(19) United States
(12) Patent Application Publication
(10) Pub. No.: US 2009/0070210 A1
(43) Pub. Date: Mar. 12, 2009

(54) Sending delayed message in response to a customer request

(76) Inventors: Gregory T. White, Carlisle, MA (US); Scot D. Junkin, Sturbridge, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/900,212

(22) Filed: Sep. 10, 2007

(51) Int. Cl. G06Q 30/00

(52) U.S. Cl. 705/14

(57) ABSTRACT

A technology platform for the delivery of advertisements and messages in response to a user making a voice based connection via an end user communications device. More specifically, the invention provides advertising supported information services. In one specific embodiment, a first station includes connection circuitry to setup a voice based connection between a second station and the first station. The second station configured to play an advertisement to the first station, provide an offer to receive at least one delayed message associated with the advertisement to the first station, and send the at least one delayed message in response to the user at the first station accepting the offer. Alternatively, the message may also be sent to an email account if the first station is not capable of receiving a text message. Moreover, the advertisement may or may not be based on the user's interests.

### BACKGROUND OF THE INVENTION

In business interactions, information may be communicated to customers or potential customers at various stages in the sales, service and support cycles. In some cases, it may be desirable to deliver messages through one or more electronic channels, such as, for example, E-mail, fax, web pages, or automated voice calls. As mobile telephones and other handheld devices have become more ubiquitous, text messaging, e.g., in the form of short message service (SMS) or premium short message service (PSMS) messages, has become an increasingly desirable communications medium for allowing businesses to interact with customers. For example, in situations where timing is critical and/or where immediate information is desired, SMS messaging can be used as a “hotline”, e.g., for marketing of time-sensitive promotions, or to notify a customer of events such as shipments or electronic transactions. As an indication of its popularity, it was recently reported that one of the largest wireless service provider in the nation set a record of 10 billion SMS messages in June 2007.

Moreover, telephone directory assistance continues to be an extremely important service for consumers and businesses. Currently, most phone systems charge extra for the look up of the names and addresses and numbers of general or specific businesses. The average cost billed for these calls is now in excess of $1.00.

Directory assistance services are thus an enormous revenue center for both wired and wireless carriers, with profit margins rumored to be in the 90% range. Nearly all directory assistance calls which are placed by consumers are those looking for a phone number for a specific business or individual that could traditionally be found manually in the “white pages.”

Consumers may be looking for a business for which they know a category (i.e., plumber, lawyer, travel agent, taxi, etc.) but for which they do not know a name and/or location. There is also no way for a consumer to use a telephone to search by “keyword” for a product or service they wish to purchase. These types of searches are still reserved for consumers to use traditional sources such as the “yellow pages.” Increasingly now, consumers can also turn to internet based on-line directories and search engines for this type of search.

However, such directory searches often tend to be local in nature, meaning that the consumer is actually looking for a merchant in their immediate geographic area. It is this reality which has driven the two largest internet search engine advertising platforms, Google and Overture (a Yahoo! subsidiary), to launch localized advertising options for their so-called Cost Per Click (CPC) based advertising services.

There has, of course, also been much attention paid to the online keyword search market. Yahoo's acquisition of Overture in July 2003 for $1.6 billion led to a doubling of Yahoo's market capitalization. Almost all of Google's $10 Billion revenue in 2006 was derived from their “AdWords” paid search product. Both Microsoft and AOL compete with their own online search solutions.

But the reality is that of the 13 million small to medium size businesses in the United States, few of them advertise using web based services. The reasons for this are many, but include at least the fact that in order to advertise successfully online, a business must have both a viable website presence as well as the technical infrastructure to be able to handle the leads they receive, typically via e-mail. Furthermore, businesses need to have technical savvy in order to be able to create and manage one or more paid search campaigns. Perhaps it is for these reasons alone that businesses spent about one-half of their advertising budget on yellow pages ads but less than 10% for internet search advertising.

While a cottage industry of search engine marketing companies has developed in order to bring more and more businesses online with paid search, the reality is that the majority of businesses are left out. Other reasons for this include the fact that because of the global nature of the internet, paid keyword search is the more effective for products and services which do not require contact with a local market. Furthermore, because of the bidding process for placement of paid advertisements, many small businesses are “squeezed out” of the internet search market by large national players who can afford to pay more in order to capture online leads.

The majority of small businesses thus still rely primarily on the telephone as their primary means of generating sales leads. In an era where personal video recorders threaten to alter the landscape of television advertising, commercial free satellite radio systems limit the effectiveness of local radio advertising, and the national “Do Not Call List” has effectively eliminated traditional telemarketing, merchants and service providers looking to market themselves locally are actually becoming more limited in their choices.

### SUMMARY OF THE INVENTION

A method and corresponding system for providing cross marketing of advertisements and messages when a consumer or user makes a request, such as, for Directory Assistance. For example, if the consumer is interested in a particular product, such as airline tickets and he/she is calling Directory Assistance, an ad that may or may not be based on his/her interests is played. The consumer may have an option of receiving a message after the ad is played to remind him/her of the ad. In the example, this may be a time sensitive promotion for airline tickets. The format of the message may be any information which can be digitally encoded, such as images, videos, games, voice, songs, and texts.

In another example, the ad may be unrelated to the request, such as a promotion for a television show. The system may delay sending the message until a specified time as may be desired by the advertiser. The specified time, for example, may be half an hour before a start of the television show or a day before the end of the sale for the airline ticket. Moreover, there may be multiple messages. For example, one message is sent at the termination of a calling party requesting directory assistance and another message, for example, half an hour before the start time of the television show.

An example embodiment includes, a first station includes connection circuitry to setup a voice based connection between a second station and the first station. The second station configured to play an advertisement to the first station, provide an offer to receive at least one delayed message associated with the advertisement to the first station, and send the at least one delayed message in response to a user at the first station accepting the offer.

The nature of messaging yields a robust set of options for the time to send the message. These include:

at the termination of a calling party requesting, for example, Directory Assistance,

anytime prior to an expiration of a promotion associated with the advertisement, such as an hour before a start of a television show,

at a time specified by the advertiser, or

a specific time day, day of week, etc.

The second station may play an ad that is based on the user's interest. The user's interest may be based on behavioral information from past requests. By knowing exactly what a particular user is looking for at the moment he/she is looking, one can target his/her scope of interest with an ad and follow up with a message associated with the ad. The message may be a Short Message Service (SMS), Premium Short Message Service (PSMS), Multimedia Message Service (MMS), or some other medium.

In one embodiment, to determine which ad to play and send a message, the second station identifies an incoming telephone number from using a reverse Automatic Number Identifier (ANI) database and queries a user profile database for a match of the incoming telephone number. If there is a match, the second station determines and selects the ad based on the user/consumer profile to play and send the message. If the query returns multiple ads, a selected ad is chosen automatically based on predetermined criteria such as maximizing advertising revenue, user/consumer satisfaction ratings, ranking of consumer offers, round robin selection, random process, or the like. The selected advertisement can be retrieved as a stored audio file or a text file, such as a SMS or MMS notification. It should be understood that the advertisement should not be limited to text, but encompasses any information which can be digitally encoded, such as images, videos, games, etc.

In another embodiment, a gateway may determine whether a calling party from the first station is capable of receiving the message, for example a text message. The first station, for example, may be a cellular wireless telephone, pager, or the like that is capable of receiving text messages. If, the first station is not capable of receiving the text messages, for example, a Plain Old Telephone System (POTS), the second station may search for the user's email address in a user profile database.

The nature of the telephone yields a robust set of advertisement targeting options. These include:

a geographical location associated with a calling party,

general location information determined by the ANI lookup of the calling party,

specific location information from, for example, emergency 911 location data available from wireless systems,

demographic and/or user information obtained by ANI lookup in combination with other databases, or

other criteria, such as time of day, day of week, etc.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating example embodiments of the invention.

FIG. 1 is a high level network diagram of a system employing example embodiments of the invention to deliver audio advertisements and optional text messaging notification of the same in response to a calling party making a request for information, such as Directory Assistance;

FIGS. 2A-2D are flow charts of steps performed by the system to play an audio advertisement and send at least one text message in accordance with an example embodiment of the invention;

FIG. 3 is a text message in accordance with an example embodiment of the invention; and

FIG. 4 is a flow chart of steps performed by the system to play a video advertisement and send at least one video message in accordance with an example embodiment of the invention.

### DETAILED DESCRIPTION OF THE INVENTION

A description of example embodiments of the invention follows.

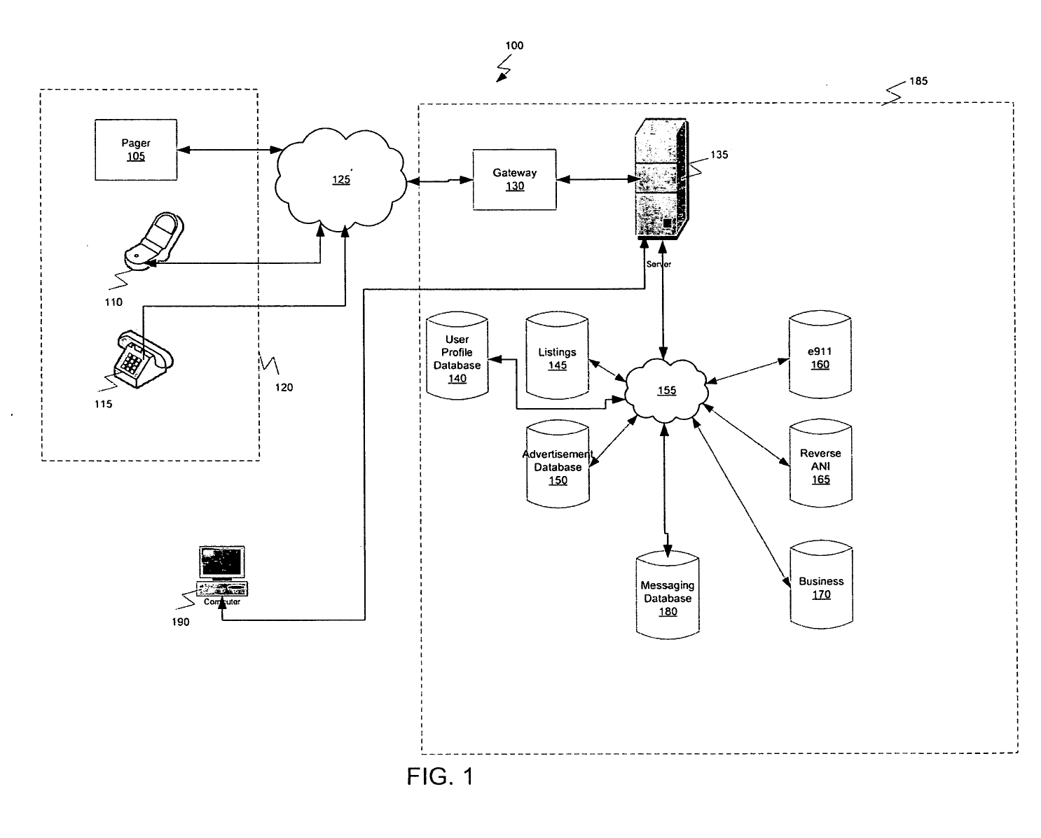

With reference to FIG. 1, a system 100 for use in a telecommunications network can be implemented using an application server 135 which can receive information originating from a communications network 125 (e.g., a circuit switch such as a Public Switched Telephone Network (PSTN), cellular network, wireless network (e.g. wireless fidelity (WiFi)), or a packet switch network, such as an Internet Protocol network), via a call originating from a user/consumer who is using an end user device (or first station 120) such as a pager 105, cell phone 110, or plain old telephone 115. The system 100 may include a gateway 130 to determine if the first station 120 (e.g., pager 105, cell phone 110, plain old telephone 115, or similar end user devices) is capable of receiving messages, such as text messages. Although the gateway 130 is shown as a separate entity, one skill in the art will recognize that the gateway 130 may be incorporated, for example, as part of the network communications 125 or server 135.

The message may be a Short Message Service (SMS) text notification, Multimedia Message Service (MMS), or a notification over a Skype network. The Skype user directory may be entirely decentralized and distributed among various nodes in a network. The SMS is a feature available in most modern digital phones, that lets users receive and send short text messages. The text messages may range from 150 to 160 characters long.

The application server 135 is connected through the internet 155 (and/or local networks) to various other databases and/or information servers. These include, for example, a listings database 145, an advertisement database 150, a user profile database 140, a messaging database 180, a reverse Automatic Number Identifier (ANI) database 165, an emergency 911 number look-up database 160, a business listings database 170 and other possible paid-subscription or free services or databases. FIG. 1 should be considered a logical view of the various databases; that is, although the drawings illustrates these databases as individual discrete entities each having their own server, it should be understood that one, several, or all of the databases may be consolidated in one physical machine, or that one or more of the databases may be so large as to be distributed among multiple servers and physical processors and/or disk drives. Moreover, it should be understood that the first station 120 may include other voice over IP devices that support messaging.

A consumer or calling party using the first station 120 dials a telephone number used to access a second station 185 (e.g., a Directory Assistance Service). The second station 185 selects one of the advertisements in the user listings database 145 and plays the selected advertisement to the first station 120. The listings database 145 contains information concerning advertisers who have paid a fee to be listed in the system or agreed to pay for each call that the advertisement is played to the first station 120. The listings database 145 identifies one or more ads associated with one or more advertisers. As will be understood shortly, if multiple ads are identified in response to the call, then, typically one is identified as the selected ad to be played, based on a number of criteria such as which advertiser bid the most for the ad, or which advertiser provides the best offer to the consumer, etc. The identified ad is then retrieved from the advertisement database 150 advertising messages. The user then hears the advertising message(s) in response to dialing the telephone number to access the second station 185. It should be understood that dialing the telephone number may include the use of a push button or voice activated first station 120.

The ads and text messages associated with the ads may be stored as digitally encoded audio files (MP3, WAV, etc.) or as text files. In the case of digitally encoded audio files, they are played back to the user 102 as an audio signal. However, if stored as a text file, they may first be processed through text to speech (TTS) equipment in an Interactive Voice Response (IVR)/Automated Voice Recognition (AVR) System (not shown).

At the conclusion of playing the advertisement, the second station 185 provides an offer to receive a text message notification associated with the advertisement to the first station 120. If the user decides not to accept the offer, the user continues with the process of getting Directory Assistance, for example, as described in U.S. Patent Publication No. 2006/0171520 naming Scott A. Kliger as an inventor, filed Nov. 29, 2005, herein incorporated by reference.

However, if the user accepts the offer, the second station 185 sends a text message notification associated with the ad to the first station 120. The user/consumer may then continue with the Directory Assistance process as also described in the above referenced U.S. Patent Publication No. 2006/0171520.

The second station 185 using the gateway 130 may determine if the first station 120 is capable of receiving text messages. If the user is using a first station 120 that is not capable of receiving text messages, such as plain old telephone 115, the second station 185 may send the text messages to a computer 190 using the user's email address stored in the user profile database 140. The user at an earlier time may have setup an account with the second station 185, for example, using the computer 190 to access a registration website. As part of the registration process, the user would include his/her email address that is then stored in the user profile 140.

However, if the user is using a first station 120 that is capable of receiving text messages such as cell phone 110, the second station 185 sends the text messages to the cell phone 110. The reverse ANI database 165 may be used to identify the calling party's telephone number. (Please note that the standard ANI service provides information concerning the calling parties' telephone number, such as might also be determined from the phone number portion of a “user ID” determination, although ANI is not the same service as user ID in the United States.) The application server 135 may delay sending the text messages until a specified time as chosen by the advertisers. The specified time may include:

at the termination of a calling party requesting Directory Assistance,

anytime prior to an expiration of a promotion associated with the advertisement, such as an hour before a start of a television show,

at a time specified by the advertiser, or

a specific time day, day of week, etc.

The listings database 145 is not necessarily limited to just having a list of businesses as grouped into categories by a local telephone exchange service provider. For example, custom groupings may be determined by the system provider, such as by grouping businesses by their telephone number, or other combinations without regard to specific, predefined business or services categories.

Further information may be maintained in a user profile database 140 that is kept on a per telephone number basis. Such information may include, but is not limited to, data indicating past offer of text messages and responses to those offers. It should be understood that other identifiers may be used to specify a particular individual user. For example, the system 100 may keep data on a home phone number, a mobile phone number, and an office phone number together with a unique identifier for the individual. This may also be beneficial as many people now use more than one number.

The service provider operating application server 135 may thus typically develop its own listings database 145 that are paid listings. The paid listings may be categorized by and/or prioritized by highest bid, proximity to the user or any one of a number of different criteria supported by the system 100. A listings query to play the ad can also be satisfied by a random search, a geography match, matching an advertiser willing to pay the most to reach a user of indicated type previous positive user/consumer feedback or other criteria. Various partial and/or weighted combinations of these factors may also be used in determining the ads to be played back. The selection of a specific advertisement is based on several possible criteria including:

geographical location associated with a calling party,

general location information determined by the ANI lookup of the calling party,

specific location information from, for example, emergency 911 location data available from wireless systems,

demographic and/or consumer information obtained by ANI lookup in combination with other databases, or

other criteria, such as time of day, day of week, etc.

The following exchange between a user (U) using a first station 120 (e.g., cell phone 110) and the application server (S) 135 is a general example of an exchange where the user is obtaining a text message as part of dialing a Directory Assistance without being charged for the call. The user needs a lawyer in this example.

U: <Dials Directory Assistance.>

S: “Did you know that the most popular television show is Heroes? Catch it on NBC on Monday at 9 PM. Would you like to receive a text message to remind you of the show? If yes, please press 2, otherwise press 1 to continue.”

U: <The user presses 2 on his/her cell phone 110>

S: “Thank you. A text message will be sent to remind you of the show.”

S: “Please tell me the service you are looking for.”

U: “I need a lawyer.”

At this point the process of obtaining Directory Assistance continues, for example, as explained in the U.S. patent application Ser. No. 11/291,094.

At a later time, for example, 1 hour before the start of the television show Heroes, thus, Monday at 8 PM, a text message is sent to the cell phone 110.

S: <A body of the text message>“Don't forget to watch Heroes. The show starts at 9 PM on NBC.”

This text message serves as a reminder for the user of their interest in watching Heroes.

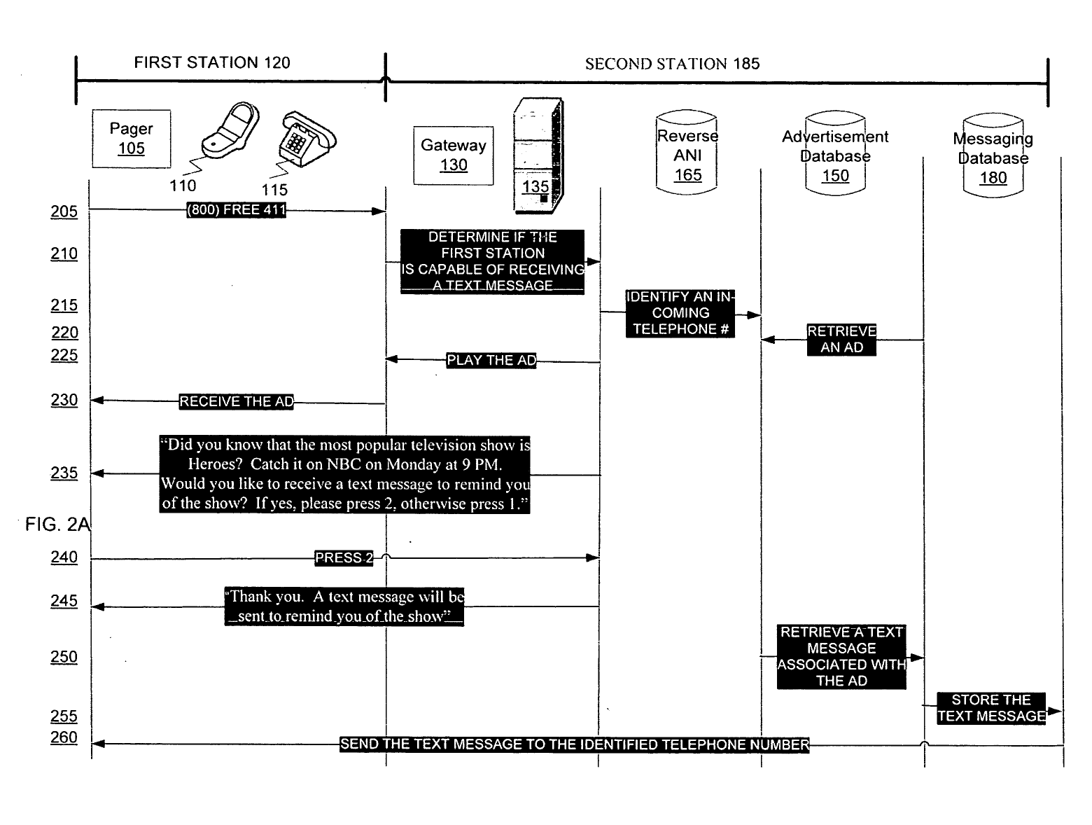

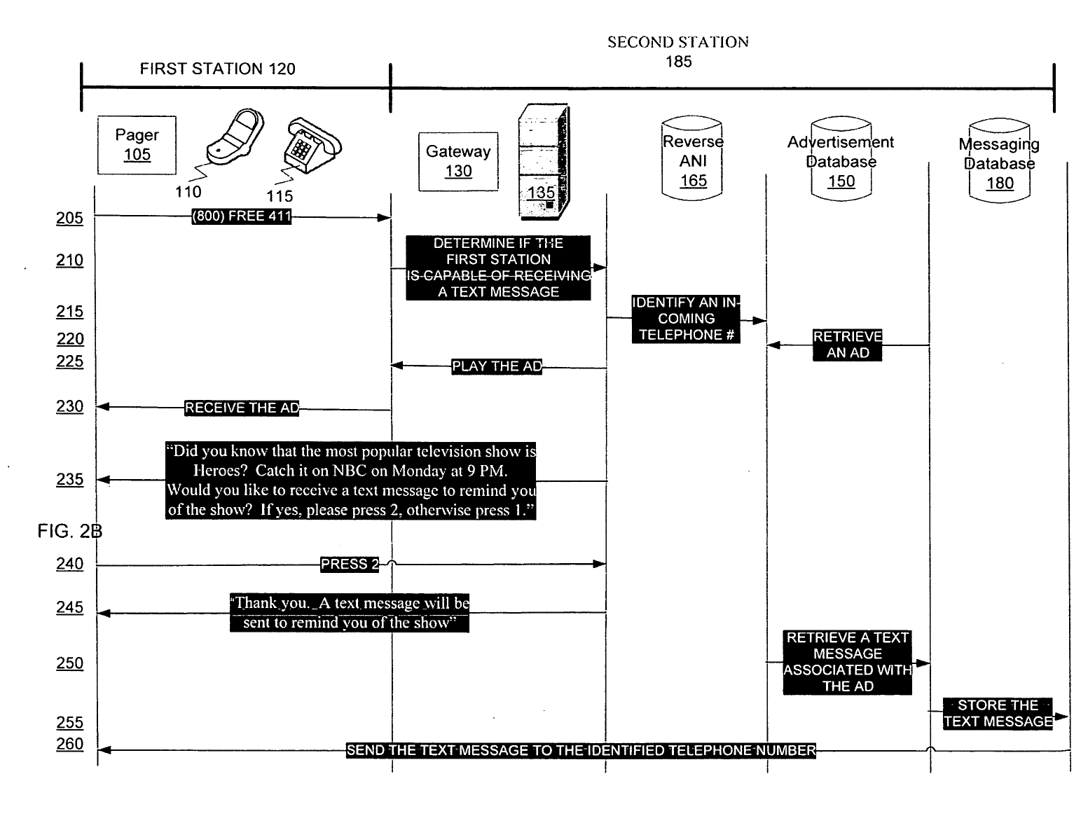

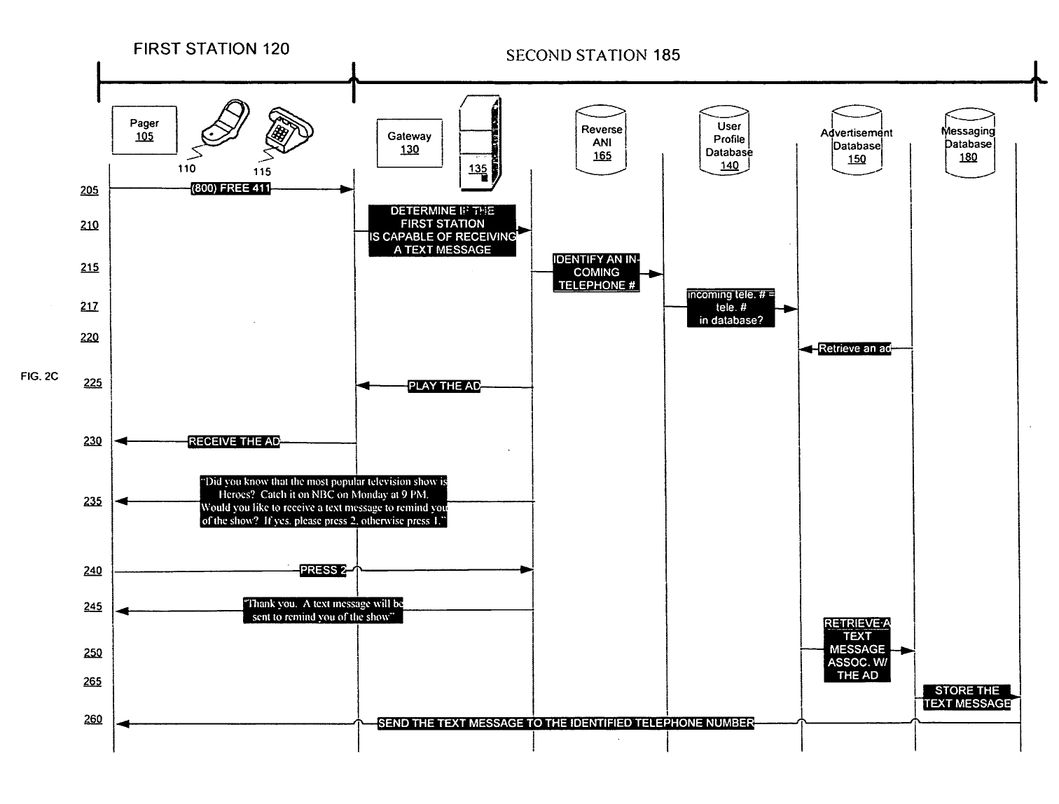

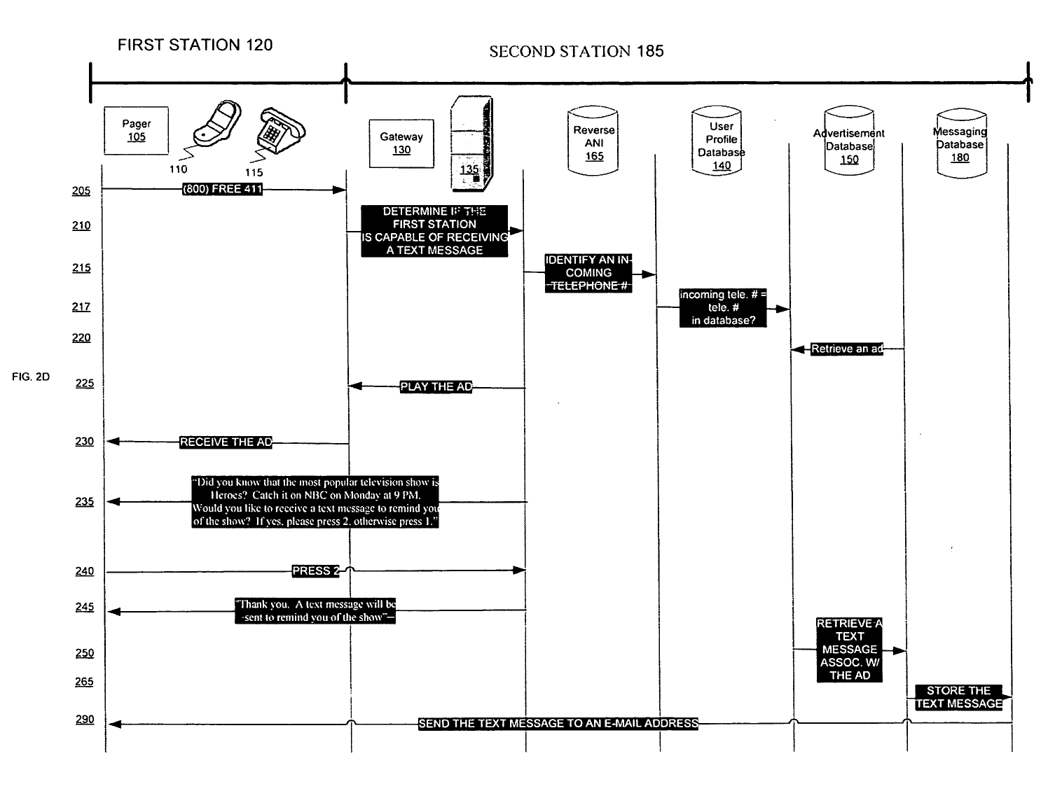

FIG. 2A illustrates an example of how a text message may be processed by the system 100 in more detail. Certain components of the system 100 of FIG. 1 are listed across the top of the page, with a sequence of steps detailed beneath them. In this case, the user/consumer accepts an offer to receive a text message.

Here, the user is using a cell phone 110 that is able to receive text messages. The cell phone 110 is assigned a telephone number of 303-443-1223. In a first step 205, the user uses the cell phone 110 to dial the ad-supported information service, such as by dialing a toll-free 800 number. After the call is connected, in step 210, the gateway 130 determines whether the cell phone 110 is capable of receiving text messages. In this example, the cell phone 110 is capable of receiving text messages. In step 215, the reverse ANI database 165 identifies an incoming telephone number by the calling party to be 303-443-1223. This number will be used to send a text message.

The system application server 135 retrieves an ad from the advertisement database 150 in step 220. The selection of the ad is based on a variety of criteria, but in this example, it is a random selection. The system application server 135 plays the selected ad to the user at step 225. The user receives the ad in step 230 and hears in step 235:

S: “Did you know that the most popular television show is Heroes? Catch it on NBC on Monday at 9 PM. Would you like to receive a text message to remind you of the show? If yes, please press 2, otherwise press 1.”

After which the user presses 2 on his/her cell phone 110 at step 240. The user then hears in step 245:

S: “Thank you. A text message will be sent to remind you of the show.”

In response to the user pressing 2 on his/her cell phone 110 at step 240, the system application server 135 retrieves a text message associated with the advertisement in the advertisement database 150 at step 250. The system application server 135 stores the retrieved message in the messaging database 180 at step 255. The messaging database 180 stores the message until a specified time. At the specified time, the system application server 135 sends the text message to the cell phone 110 having the telephone number 303-443-1223 at step 260. In this example, the specified time is one hour before the start of the television show. Thus at 8 PM, the system application server 135 sends the text message to the cell phone 110. The text message may say:

S: “Don't forget to watch Heroes. The show starts at 9 PM on NBC.”

The specified time includes: at the termination of a calling party requesting Directory Assistance, anytime prior to an expiration of a promotion associated with the advertisement, such as an hour before a start of a television show, at a time specified by the advertiser, or a specific time of day, day of week, etc.

FIG. 2B illustrates another example of how a text message may be processed by the system 100 in more detail. In FIG. 2B, an additional text message is sent to the cell phone 110 in step 265. The system application server 135 may immediately send the additional text message in response to the user pressing 2 at step 240. The additional text message is a confirmation text message that may or may not include the text message that is associated with the advertisement.

FIG. 2C illustrates another example of how a system 100 selects an advertisement to play based on a user profile in more detail. After the reverse ANI database 165 identifies the incoming telephone number by the calling party to be 303-443-1223, the system 100 uses the incoming telephone number to perform a query of the user profile database at step 217. The user profile database 140 may be kept on a per telephone number basis. Such information may include, but is not limited to, data indicating past offer of text messages and responses to those offers. It should be understood that other identifiers may be used to specify a particular individual user. For example, the system 100 may keep data on a home phone number, a mobile phone number, and an office phone number together with a unique identifier for the individual. This may also be beneficial as many people now use more than one number. A typical user profile may also contain several entries, such as the user's name, e-mail address, and address with ZIP code, and number of profile entries, with each entry being a record of a past interaction with the system 100. A record may contain items such as the date, day of the week, and time the request for directory assistance was made. The user may have included the items in the user profile sometime in the past by registering with the service provider via, for example, a computer 190 or mailing in an application to the service provider.

If there is no match of the telephone number in step 217, the system may, for example, randomly select an advertisement. If there is a match of the telephone number, the system 100 selects an advertisement based on information, such as pass history of accepting the offer to receive text messages. The selected advertisement may be retrieved from the messaging database 180 in step 220. In a case where there may be a list of potential advertisements to play, the system 100 may select from among multiple advertisements based on different criteria as desired by the service provider. This decision may be aided by additional information kept with each entry in the ad database 150. For example, the criteria may include maximizing advertising revenue based on an order of an expiration time of a promotion associated with the advertisement, maximizing user satisfaction determination, or rotating system such as a round robin selection.

As explained above, the criteria for determining which ad to play in response to a user dialing directory assistance can be based on a number of factors. Thus, if multiple advertisers have paid for listings 145, it may be desirable to not have the user hear the same advertisement each time. Thus, data can be maintained in the user profile database 140, to allow the system 100 to recall which ads had previously been played to the same first station 120.

FIG. 2D illustrates an example of how the system 100 sends text messages to an email account. In step 210, the gateway may determine that the first station 120, for example, a pager 105, is not capable of receiving text messages. Therefore, as part of step 217, if there is a match, a search is made for the user's email address stored in the user profile database 140. This email address is used in step 290 to send the text message.

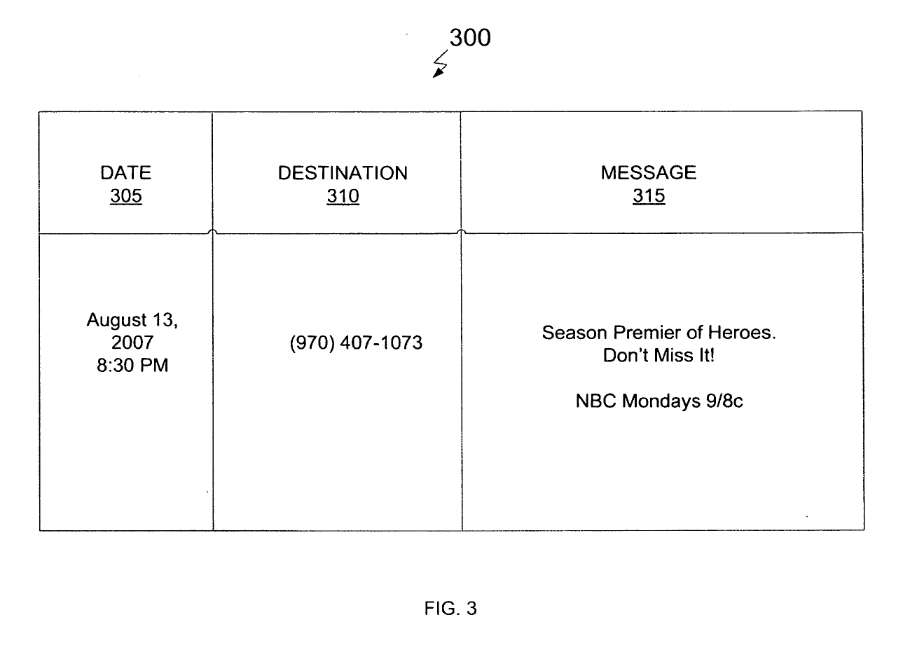

FIG. 3 illustrates an example of a message 300 that is text based. It should be understood that the message 300 may be in another format, such voice, video, images, or any combination thereof. The message 300 may include a date 305 for sending the message 300, a destination address 310, and a body of the message 315. The date 305 may also include a specific time to send the message as desired by the listings 145. The destination address 310 is where the message 300 is sent. This may be an incoming telephone number as identified by the reverse ANI look up 165 or a user's email address associated with the incoming telephone number. The message 300, for example, may be sent half an hour before the start of the television show Heroes. Thus, the message 300 may be delivered on a date 305 of Aug. 13, 2007 at 8:30 PM to the destination address 310 as (970) 407-1073. The body of the message 315 may be “Season Premier of Heroes. Don't Miss It! NBC Mondays 9/8 c”.

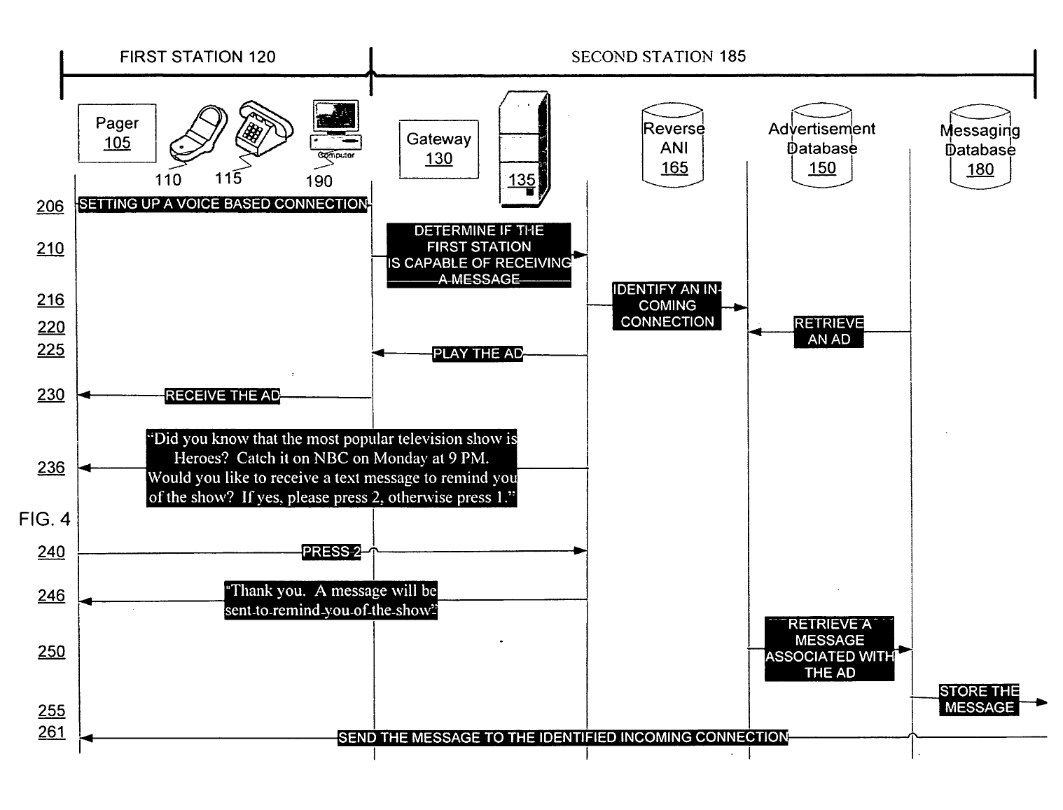

FIG. 4 illustrates an example of how a message, such as a video message may be processed by the system 100 in more detail that is not in the context of Directory Assistance. The user sets up a voice based connection between a first station 120 and a second station 185. Certain components of the system 100 of FIG. 1 are listed across the top of the page, with a sequence of steps detailed beneath them. In this case, the user accepts an offer to receive a video message.

Here, the user is using a cell phone 110 that is able to receive video messages. However, it should be understood that the user may also use other devices such as a pager 105, telephone 115, computer 190, or other handheld devices to make the request. The cell phone 110 is assigned a telephone number of 303-443-1223. In the first step 206, the user uses the cell phone 110 to establish a voice based connection with the second station 185. The user may establish a voice based connection by pushing a button on the cell phone 110, similar to using a walkie-talkie, and making the request:

After the voice based connection is established, in step 210, the gateway 130 determines whether the cell phone 110 is capable of receiving video messages. In this example, the cell phone 110 is capable of receiving video messages. In step 216, the reverse ANI database 165 identifies an incoming connection by the party to be 303-443-1223. This number will be used to send a video message. It should be understood that there are other types of identifying information and/or some other technique for identifying the source of the connection, such as user identification (CID) information. The CID information may include text data including the user's name and/or address.

The system application server 135 retrieves an ad from the advertisement database 150 in step 220. The selection of the ad is based on a variety of criteria, but in this example, it is a random selection. The system application server 135 plays the selected ad to the user at step 236. The selected video ad may be displayed on the screen of the cell phone. The user receives the ad in step 230 and sees the video in step 236. The second station 185 sends an offer to receive at least one delayed message associated with the advertisement to the first station 120.

S: “Did you know that the most popular television show is Heroes? Catch it on NBC on Monday at 9 PM. Would you like to receive a message to remind you of the show? If yes, please press 2, otherwise press 1.”

After which the user presses 2 on his/her cell phone 110 at step 240. The user then hears in step 246:

S: “Thank you. A message will be sent to remind you of the show.”

In response to the user pressing 2 on his/her cell phone 110 at step 240, the system application server 135 retrieves a message, such as a video message associated with the advertisement in the advertisement database 150 at step 250. The system application server 135 stores the retrieved message in the messaging database 180 at step 255. The messaging database 180 stores the message until a specified time. At the specified time, the system application server 135 sends the message to the cell phone 110 having the telephone number 303-443-1223 at step 261. In this example, the specified time is one hour before the start of the television show. Thus at 8 PM, the system application server 135 sends the video message to the cell phone 110.

While this invention has been particularly shown and described with references to example embodiments thereof, it will be understood by those skilled in the art that various changes in form and details may be made therein without departing from the scope of the invention encompassed by the appended claims.

It should be understood that any of the above-described flow diagrams of FIGS. 2A-2D and 4 or underlying methods used to implement aspects related to the networks of FIG. 1 may be implemented in the form of hardware, firmware, software or any combination thereof. If implemented in software, the software may be in any suitable form of software that can be stored on any form of machine-readable medium (e.g., CD-ROM, floppy disk, tape, random access memory (RAM), read-only memory (ROM), optical disk, magnetic disk, FLASH memory, system memory, and hard drive), and loaded and executed by at least one general purpose or application specific processor. The software may be downloaded to nodes in a network via any form of network link including wired, wireless, or optical links, and via any form of communications protocol.

It should be further understood that the flow diagrams of FIGS. 2A-2D and 4 are merely example embodiments of the invention, and other configurations, arrangements, additional blocks, fewer blocks, and so forth are possible in other embodiments. For example, the techniques illustrated in these figures may be performed sequentially, in parallel or in an order other than that which is described. In addition, it should be appreciate that not all of the techniques described are required to be performed, that additional techniques may be added, and that some of the illustrated techniques may be substituted with other techniques.

It should be further understood that the message associated with the advertisement may be over email, Short Message Service (SMS), Multimedia Message Service (MMS), or some other medium and is not limited to only text based technology.

What is claimed is:

1. A method for use in a network, the method comprising:
setting up a voice based connection between a first station and a second station;
playing an advertisement to the first station;
sending an offer to receive at least one delayed message associated with the advertisement to the first station; and
sending the at least one delayed message in response to a user at the first station accepting the offer.

2. The method of claim I wherein sending the at least one delayed message in response to the user at the first station accepting the offer is sending a Short Message Service (SMS) notification, Multimedia Message Service (MMS) notification, video, image, song, or any combination thereof.

3. The method of claim 1 wherein sending the offer includes determining whether the first station is capable of receiving the at least one delayed message associated with the advertisement.

4. The method of claim 1 wherein playing the advertisement to the first station includes:
selecting the advertisement associated with a criteria; and
retrieving the selected advertisement from an advertisement database.

5. The method of claim 1 wherein sending the at least one delayed message includes:
retrieving the at least one delayed message;
storing the at least one delayed message; and
delaying the sending of the at least one delayed message until a specified time associated with the advertisement.

6. The method of claim 5 wherein the specified time is prior to an expiration of a promotion associated with the advertisement.

7. The method of claim 5 wherein the specified time is prior to a start time of the advertisement.

8. The method of claim 1 wherein sending the at least one delayed message includes immediately sending the at least one delayed message associated with the advertisement in response to accepting the offer.

9. The method of claim 1 further including at the first station, receiving the at least one delayed message associated with the advertisement in response to accepting the offer.

10. The method of claim 1 wherein sending the at least one delayed message includes:
searching for an email address of the user in a user profile database; and
sending the at least one delayed message to the email address of the user.

11. The method of claim 1 wherein playing the advertisement to the first station includes:
querying for a match of an incoming telephone number to a plurality of telephone numbers listed in a user profile database;
selecting the advertisement based on a profile of the user, if there is the match; and
retrieving the selected advertisement to be played.

12. A system for use in a network, the system comprising:
a first station includes connection circuitry to setup a voice based connection between a second station and the first station; and
the second station configured to play an advertisement to the first station, provide an offer to receive at least one delayed message associated with the advertisement to the first station, and send the at least one delayed message in response to a user at the first station accepting the offer.

13. The system of claim 12 wherein the at least one delayed message is a Short Message Service (SMS) notification, Multimedia Message Service (MMS) notification, video, image, song, or any combination thereof.

14. The system of claim 12 further including a messaging gateway configured to determine whether the first station is able to receive the at least one delayed message associated with the advertisement.

15. The system of claim 12 wherein the second station further includes:
a listings database having information about at least one advertiser therein, the listing database configured to select the advertisement based on a criteria and retrieve the selected advertisement from an advertisement database.

16. The system of claim 15 wherein the criteria is based on maximizing advertisement revenue.

17. The system of claim 12 wherein the second station further includes:
an application server configured to delay the sending of the at least one delayed message until a specified time associated with the advertisement; and
a messaging database configured to store the at least one delayed message until sending the at least one delayed message.

18. The system of claim 17 wherein the specified time is prior to an expiration of a promotion associated with the advertisement.

19. The system of claim 17 wherein the specified time is prior to a start time of the advertisement.

20. The system of claim 12 wherein the first station is configured to receive the at least one delayed message associated with the advertisement in response to an acceptance of the offer.

21. The system of claim 12 wherein the at least one delayed message includes:
a date to send the at least one delayed message;
a destination address to send the at least one delayed message; and
a message associated with the advertisement.

22. The system of claim 21 wherein the destination address is an incoming telephone phone number or an email address.

23. The system of claim 12 wherein the second station further includes an application server configured to search for an email address of the user in a user profile database.

24. The system of claim 12 further including:
a user profile database having a plurality of user telephone numbers associated with a plurality of user profiles; and
an application server configured to query for a match of an incoming telephone number to the plurality of user telephone numbers, and if there is the match, automatically determine and select the advertisement to play based on the plurality of user profiles.
